(19) United States
(12) Patent Application Publication
(10) Pub. No.: US 2010/0184546 A1
(43) Pub. Date: Jul. 22, 2010

(54) DAMPING DEVICE OF A MECHANICAL TENSIONING SYSTEM FOR A TRACTION MECHANISM DRIVE

(75) Inventor: Johann Singer, Grossenseebach (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/667,618

(22) PCT Filed: Jun. 13, 2008
(86) PCT No.: PCT/EP08/57496

§ 371 Date: Jan. 4, 2010

(30) Foreign Application Priority Data
Jul. 5, 2007 (DE) 10 2007 031 298.0

(51) Int. Cl. F16H 7/12

(52) U.S. Cl. 474/135

(57) ABSTRACT

A damping device of a mechanical tensioning system for a traction mechanism drive for damping pivoting movements of a tensioning arm. The tensioning arm is supported at one end by a tensioning roller on a traction mechanism and is rotatably mounted at the other end on a positionally fixed housing part, which has an annular friction element. The periphery of the friction element is a friction lining which interacts with a friction surface of the housing part surrounding the friction element. A torsional spring connects the housing part and tensioning arm. The tensioning arm is acted on with a torsional moment, generating a continuous preload of the traction mechanism which is supported on the friction element and exerts a radially outwardly acting force on the friction lining. Also, surface contact means, which act on the friction lining, transmit radial force between the torsional spring and friction lining.

### FIELD OF THE INVENTION

The invention relates to a damping device of a mechanical tensioning system for a traction mechanism drive, for example of a motor vehicle, for damping pivoting movements of a tensioning arm, which at one end is supported via a tensioning pulley on a traction mechanism and which at the other end is rotatably mounted on a fixed housing part, having an annular friction element, the circumference of which is formed as a friction lining which, in order to generate a friction torque, interacts with a friction surface of the housing part enclosing the friction element, wherein a torsion spring embodied as a coil spring, which forms a rotational force connection between the housing part and the tensioning arm and via which the tensioning arm can be subjected to a torsional moment so as to produce a continuous tensioning of the traction mechanism, is supported on the friction element and exerts an outwardly acting radial force on the friction lining.

### BACKGROUND OF THE INVENTION

Such mechanical tensioning systems use torsion springs, which in operation need to apply only a relatively small axial force component, if any, since their damping units are designed so that in contrast to conventional tensioning systems they produce the friction work via radially rather than axially directed spring forces.

In order to obtain the requisite friction work on this operating principle, a radial force component of the torsion spring, which presses the one friction lining of a friction element coupled with the tensioning arm in a radial direction against a paired friction element on the fixed housing or base part, takes effect as the tensioning arm pivots in an opening or closing direction of rotation according to the pivoting direction, carrying the spring with it by means of an inner wrap-around bush or an outer friction ring, depending on the design construction.

The torsion spring, moreover, as is usual in automatic belt tensioners, establishes a rotational force connection between the housing part and the tensioning arm and, in order to produce a continuous tensioning of the traction mechanism, exerts on the tensioning arm a torsional moment that is self-regulating through the pivoting movements or the pivoting positions of the tensioning arm, so that a tension, once set, is automatically maintained and any slipping or shimmying of the belt or traction mechanism is permanently and reliably prevented, even in the event of elongation of the traction mechanism due to aging or wear. There is therefore no need for any readjustment of the tensioning arm or the tensioning pulley.

In these tensioning systems a coil spring produced from round wire has hitherto been used as torsion spring, which is stressed in an opening and closing direction of rotation. Consequently, under the pivoting movements of the tensioning arm for damping impacts and oscillations, the friction lining is exposed radially via the spring to a comparatively high area load, since only a few spring coils, for example only the final spring coil at the end, are in direct or indirect contact with the friction lining. Furthermore, the entire radial force component of the spring, supported by its ends between the friction element and the housing or base part, is introduced into the friction element.

U.S. Pat. No. 7,004,863 B2 shows a damping device of a belt tensioner of a traction mechanism drive comprising two arched parts, which are assembled to form a divided annular element, the two parts being in contact via a lug, which is incorporated in the one part and which defines an opening gap between the annular parts. A circular segmental piece is cut out on the opposite side. The two arched parts each carry a damping band, so that a two-part friction lining forms the circumference. The arched parts form part of a divided sliding shoe, inside which an annular seat for a coil spring is formed. An elongated spring end of the coil spring is supported in the one sliding shoe half or on the one arched part, the spring end bearing with an outer contact point against an outer wall thickening and with an inner contact point against an inner bearing face of the associated sliding shoe part, so that in operation an opposing force couple acts on the protruding spring end or the contact points.

The sliding shoe is seated on a journal in a cavity of the lever arm and is torsionally secured in relation to the lever arm by a projection, which engages in the circumferential opening of the ring formed by the cut out circular segment. The lever arm is rotatably supported on a base part of the tensioning system by way of a journal-shaped connection. When the lever arm pivots on a traction mechanism drive, the friction lining interacts with a paired friction element on the inside wall of the base part to produce friction work. As the lever arm with the sliding shoe and the friction lining pivots, different, opposing tangential forces act on the two sliding shoe halves according to whether it pivots in the opening or closing direction of rotation of the spring, resulting in an asymmetrical damping factor of this tensioning system. The damping factor can be varied by way of the radial position of the contact point of the two annular parts.

The center of gravity of this known tensioning system affects the scope for adjustment of an asymmetrical damping factor. Consequently this tensioning system is, if necessary, capable of fulfilling its basic function. A disadvantage to this, however, is the relatively elaborate design of the spring support and the sliding shoe with the arched parts described. Alternatively it is also in fact possible to provide only one arched part with a seat for the spring, this part being connected to a damping shoe, which has an opening slot and which is torsionally secured in relation to the lever arm by a stop. However, apart from the fact that an asymmetrical damping factor is not adjustable with this arrangement, there is here only one friction band over a limited arched segment, that is over a limited circular sector, available for the friction work, so that the maximum attainable friction torque tends to be small.

On the other hand vehicle manufacturers are increasingly demanding simple, cost-effective tensioning devices, which are expected to afford comparatively high damping rates for a construction that is as compact and lightweight as possible, and a low supply price.

A simpler tensioning and damping device, which functions with a limbless coil spring, which acts upon a friction lining with an outwardly acting radial force in order to produce the necessary friction work, is described in earlier, previously unpublished patent applications DE 10 2007 016 007.2 and DE 10 2007 020 738.9 from the present applicant.

In this tensioning system the friction element is embodied as an integral multifunctional component, which acts as torsional moment transmitter, damping device and assembly aid. The friction element can be connected, torsionally secured, to the tensioning arm, for example via a centric slip-on gearing or a simple interlock. In addition. an expansion element, preferably a spring tab, integrated into the friction element, can serve to separate the tensioning arm and the housing part in an axial direction during assembly of the unit, thereby facilitating series production on an automated assembly line. In the case of the multifunctional part, a friction ring, which forms the circumference of the friction element, conforms elastically to a surrounding, corresponding friction surface of the housing part. One end of the limbless torsion spring is braced against a stop or connecting link in the friction element connected to the friction lining. At least the end coil of the spring here bears directly on the friction lining. There is no need for an additional spring seating part. Besides its torsional force and radial force components the torsion spring may also have a comparatively weak axial force component, allowing it to function as compression spring for an axial bearing and/or for balancing the tensioning arm in opposition to incident tilting moments.

The limbless spring and the simple construction of the friction ring, in particular, make this damping device very compact, cost-effective to manufacture and easy to assemble. It has emerged, however, that the direct, linear contact between the end coil or coils of the torsion spring and the inside of the friction lining can prove to be a problem, particularly under the increasingly high stresses of the tensioning units on belt drives in modern motor vehicles. Owing to a relatively high surface unit pressure, that is to say the specific area load on the friction lining, some creep may occur in the friction lining material, which although well chosen from tribological standpoints nevertheless has a limited strength and stability. In extreme cases this may lead to increased wear with detrimental effects on the torsional moment, that is on the belt tensioning force, and on the available friction force of the tensioning system.

### OBJECT OF THE INVENTION

The object of the invention is therefore to improve a damping device of a tensioning system, the impingement on a friction lining of which is based on radial forces of a torsion spring, so that it affords a high operational reliability and load bearing capacity, together with a long service life, but is nevertheless of simple and cost-effective design.

### SUMMARY OF THE INVENTION

The invention is based on the finding that a friction lining of a damping device in a traction mechanism tensioning system, upon which a coil spring impinges in a radial direction, can be effectively relieved and safeguarded if as much as possible of the entire impingement area available, that is to say the area of the radial inside wall of the friction lining, is used to transmit force radially outwards, thereby keeping the area load comparatively small.

The invention therefore proceeds from a damping device of a mechanical tensioning system for a traction mechanism drive, for example of a motor vehicle, for damping pivoting movements of a tensioning arm, which at one end is supported via a tensioning pulley on a traction mechanism and which at the other end is rotatably mounted on a fixed housing part, having an annular friction element, the circumference of which is formed as a friction lining which, in order to generate a friction torque, interacts with a friction surface of the housing part enclosing the friction element, wherein a torsion spring embodied as a coil spring, which forms a rotational force connection between the housing part and the tensioning arm and via which the tensioning arm can be subjected to a torsional moment so as to produce a continuous tensioning of the traction mechanism, is supported on the friction element and exerts an outwardly acting radial force on the friction lining. According to the invention the stated object is achieved by the additional provision of surface contact means which act on the friction lining in order to transmit the radial force between the torsion spring and the friction lining.

The surface contact means represent a simple way of reliably preventing increased wear of the friction lining against its inner side remote from the paired friction element of the housing part due to the impingement of the torsion spring, even when the tensioning unit is heavily stressed, and ensuring a long service life with operational reliability. In particular, it is possible to dispense with elaborate seating parts, which carry the friction lining on the outside and accommodate the spring on the inside.

In a first embodiment of the invention this is achieved by a first surface contact means, which is embodied as a reinforcement band inserted between an inside wall of the friction lining and the circumferential shell of the coil spring and conforming closely through positive interlock to the friction lining, said band serving to transmit the radial force of the coil spring indirectly over a surface area to the friction lining.

The reinforcement may be a metal strip that is clipped on, for example, or it may be composed of a fiber-reinforced plastic. Other means of mounting or attaching a reinforcement band are equally possible. A radially inner wall reinforcement integrally joined to the friction lining, for example by molding on in an injection molding process, or a simple plastic strip laid radially inside are also feasible. These measures serve to create a virtually two-component friction ring having one external friction element and an internal reinforcement.

In the case of a coil spring produced from round wire a second surface contact means may be embodied as a cylindrical shell surface, which is applied to the shell of the coil spring, at least in an area situated opposite the friction lining, and which is in direct, contact with a surface area of the radial inside wall of the friction lining.

For this purpose a cylindrical outer surface a few millimeters wide may be formed on the circumferential shell of the coil spring, for example by abrading the outsides of the coil turns in the so-called ‘centerless grinding process’.

A solution is also provided by a torsion spring produced from rectangular wire, the cylindrical shell surface of which bearing directly on the friction lining, produces a more effective surface contact than the linear contact of the coils of a round-wire spring and thereby introduces the radial force into the friction lining over a surface area, so that in operation any creep of the friction lining material is largely avoided.

Finally the cylindrical spring shell or the rectangular spring and the inside wall reinforcement or the reinforcement band may also be used in combination as surface contact means in order to afford an especially effective protection of the friction lining.

### BRIEF DESCRIPTION OF THE DRAWINGS

The invention is explained in more detail below on the basis of some embodiments and with reference to the drawings attached, in which:

FIG. 1 shows a perspective, exploded view of a tensioning system with a damping device according to the invention,

FIG. 2 shows a sectional side view of the assembled tensioning system in FIG. 1,

FIG. 3a shows a tensioning system with a second embodiment of a damping device according to the invention, and

FIG. 3b shows a friction element of the damping device according to FIG. 3a.

### DETAILED DESCRIPTION OF THE DRAWINGS

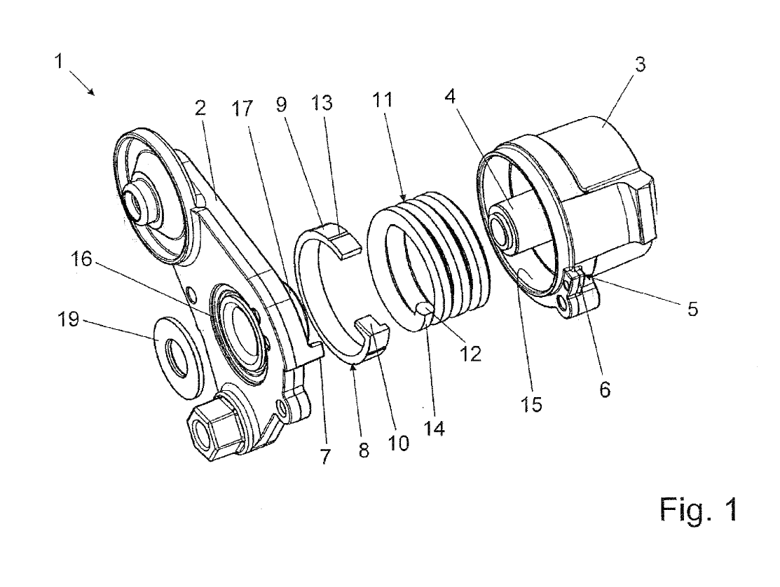

FIG. 1 accordingly shows an automatic tensioning system 1 of a traction mechanism drive, for example for driving auxiliary units on an internal combustion engine of a motor vehicle. The operating principle of such a mechanical belt tensioner is inherently familiar to the person skilled in the art. The basic construction of the tensioning system 1 largely corresponds to the aforementioned patent applications from the present applicant. The following description therefore goes into detail only on the components essential for the invention.

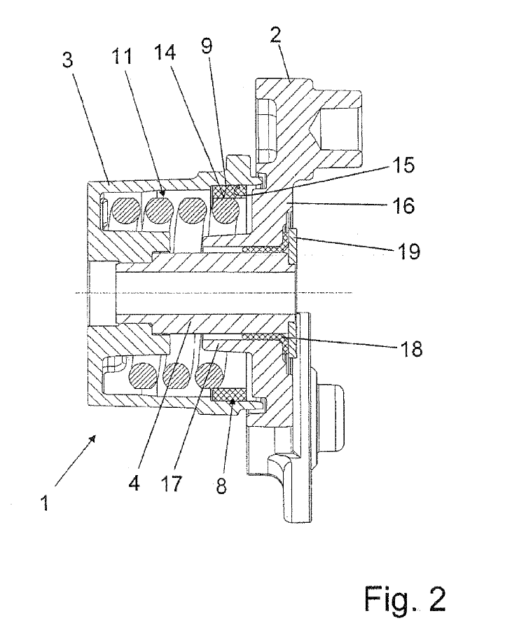

The tensioning system 1 comprises a tensioning arm 2, at one end of which a tensioning pulley (not shown) can be rotatably supported for resilient bracing against a traction mechanism (for example a belt). The tensioning arm 2 can be rotatably supported by the other end on a housing part 3 (FIG. 1, FIG. 2). For this purpose the tensioning arm 2 has a hub 16 with a hub journal 17, which protrudes in the direction of the housing part 3 and is seated by way of a slide bearing 18 on a central shaft 4 of the housing part 3 extending through the tensioning arm hub 16. In the assembled state the tensioning arm 2 and the housing part 3 are axially secured by means of a locking element 19, which on the end face of the tensioning arm 2 remote from the housing part 3 holds the tensioning arm 2 against the central housing shaft 4, for example by caulking or bolting. The housing part 3 can be immovably fixed to a machine part (not shown), such as a crankcase of the internal combustion engine. In order to limit the pivoting range of the tensioning arm 2, a travel limiter 5 is provided, comprising a radial projection 6 on the housing part 3, which interacts with one or two stops 7 on the tensioning arm 2 forming an operating window.

A damping device of the tensioning system 1 has an annular friction element 8. The friction element 8 comprises a peripheral friction lining 9 and a stop 10 connected to the friction lining 9. The friction lining 9 is made from a tribologically suitable material, for example from the material P46-PTFE15. A drainage system 13 comprising a number of transverse grooves spaced equidistantly over the outer circumference is formed on the friction lining 9 for draining off contaminants. A friction surface 15 corresponding to the friction lining 9 is provided on the housing part 3. The stop 10 serves for supporting one spring end 12 of a torsion spring 11.

The torsion spring 11 has a surface contact means 14, which is embodied as a cylindrical shell surface, which is applied through abrasion of the coils on the circumferential shell of the spring 11. A support element (not shown) for seating the other end of the spring is located inside the housing part 3. The friction element 8 can be torsionally connected to the tensioning arm 2 in a manner not further explained, so that a rotational force connection can be established between the housing part 3 and the tensioning arm 2 by way of the torsion spring 11, supported in the friction element 8 on the one hand and the housing part 3 on the other and so that under the pivoting of the tensioning arm 2 a torsional moment can be generated, which can be transmitted via the tensioning pulley in order to generate a pre-tension on a belt on the traction mechanism drive. FIG. 2 shows the tensioning system 1 in the assembled state. This illustrates the fact that the cylindrical shell surface 14 applied to the torsion spring 11 is resting flush against the inside of the friction lining 9.

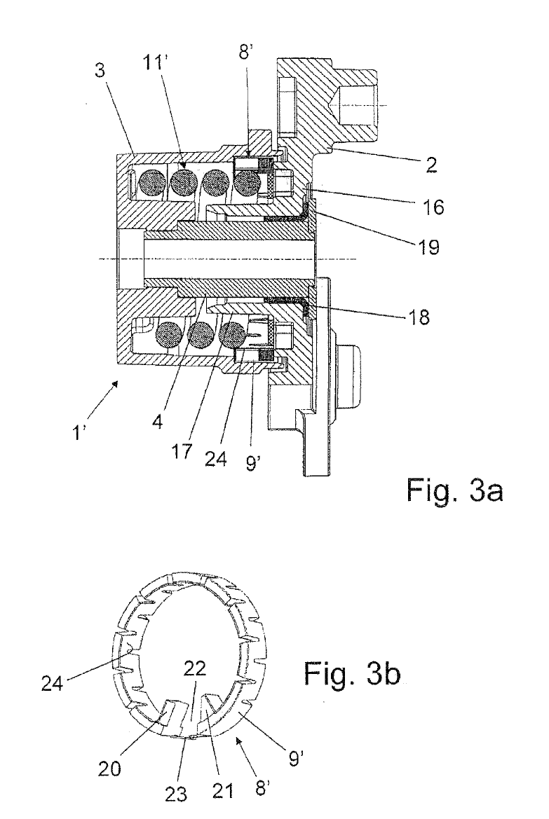

FIG. 3a shows a tensioning system 1′ of the same construction. In this system, however, a conventional torsion spring 11′ is used, that is to say one unmodified compared to tensioning systems in the state of the art. A damping device of the tensioning system 1′ comprises a friction element 8′ having a friction lining 9′. FIG. 3b shows the friction element 8′ in detail. The friction lining 9′ is alternately axially slotted in a circumferential direction and is equipped with two stops 20, 21, which define a circumferential opening 22. The circumferential opening 22 is bridged by an elastic clip 23. A second surface contact means 24 in the form of a metal strip is inserted on the inside of the friction lining 9′ for reinforcement of the friction lining 9′. The metal strip 24 is adapted to conform positively to the friction lining 9′ and has angled ends bearing against the stops 20, 21, and the same slotting, aligning with the friction lining, at the circumference.

### LIST OF REFERENCE NUMERALS

1,1′ tensioning system
2 tensioning arm
3 housing part
4 shaft
5 travel limiter
6 projection
7 stop
8,8′ friction element
9,9′ friction lining
10 stop
11,11′ torsion spring
12 spring end
13 drainage system
14 surface contact means
15 friction surface
16 hub
17 hub journal
18 slide bearing
19 locking element
20 stop
21 stop
22 opening
23 clip
24 surface contact means

1. A damping device, comprising:
a mechanical tensioning system for a traction mechanism drive for damping pivoting movements of a tensioning arm, which at one end is supported via a tensioning pulley on a traction mechanism and which at the other end is rotatably mounted on a fixed housing part, having an annular friction element, a periphery of which is formed as a friction lining which, in order to generate a friction torque, interacts with a friction surface of the housing part enclosing the friction element,
wherein a torsion spring, embodied as a coil spring, forms a rotational force connection between the housing part and the tensioning arm and via which the tensioning arm can be subjected to a torsional moment so as to produce a continuous tensioning of the traction mechanism, is supported on the friction element and exerts an outwardly acting radial force on the friction lining,
wherein surface contact means are provided, which act on the friction lining in order to transmit the radial force between the torsion spring and the friction lining.

2. The damping device of claim 1, wherein a first surface contact means is a reinforcement band inserted between an inside wall of the friction lining and a circumferential shell of the torsion spring, and conforming closely through positive interlock to the friction lining, the reinforcement band serving to transmit the radial force of the torsion spring indirectly over a surface area to the friction lining.

3. The damping device of claim 2, wherein the reinforcement band is a metal strip.

4. The damping device of claim 2, wherein the reinforcement band is a plastic band.

5. The damping device of claim 2, wherein the reinforcement band is fastened to the friction lining.

6. The damping device of claim 5, a wherein a fastening fixing the reinforcement band to the friction lining is a clamped mounting.

7. The damping device of claim 5, wherein the reinforcement band is integrally joined to the friction lining.

8. The damping device of claim 1, wherein the torsion spring produced from round wire and a second surface contact means is a cylindrical shell surface, which is applied to the cylindrical shell of the torsion spring, at least in an area situated opposite the friction lining, and which is in direct, surface area contact with an inside wall of the friction lining.

9. The damping device of claim 8, wherein the cylindrical shell surface is produced in a grinding process through abrasion of outsides of a coil turns of the torsion spring.

10. The damping device of claim 1, wherein a third surface contact means is a cylindrical shell surface of a torsion spring produced from rectangular wire which bears directly on an inside wall of the friction lining.

11. The damping device of claim 1, wherein the traction mechanism drive is designed for a motor vehicle.
